(19) United States
(12) Patent Application Publication
(10) Pub. No.: US 2015/0170531 A1
(43) Pub. Date: Jun. 18, 2015

(54) METHOD FOR COMMUNICATING WELLNESS-RELATED COMMUNICATIONS TO A USER

(71) Applicant: Lark Technologies, Inc., Mountain View, CA (US)

(72) Inventors: Julia Hu, Mountain View, CA (US); Jeff Zira, Mountain View, CA (US)

(21) Appl. No.: 14/572,648

(22) Filed: Dec. 16, 2014

Related U.S. Application Data
(60) Provisional application No. 61/916,701, filed on Dec. 16, 2013.

(51) Int. Cl. G09B 5/00; G09B 19/00

(52) U.S. Cl. CPC G09B 5/00; G09B 19/00

(57) ABSTRACT

One variation of a method for providing wellness-related communications to a user includes: applying a record of activity events performed by the user over a period of time to a communication engine to generate a first communication for the user, the communication engine supported within a native wellness platform application executing on a computing device affiliated with the user; displaying the first communication within a textual conversation feed within the native wellness platform application; receiving a response to the first communication from the user through the textual conversation feed; correlating the response with a human involvement trigger; based on the human involvement trigger, prompting a human coach to communicate with the user; and displaying a second communication within the textual conversation feed, the second communication entered by the human coach.

### CROSS-REFERENCE TO RELATED APPLICATIONS

This Application claims the benefit of U.S. Provisional Application No. 61/916,701, filed on 16 Dec. 2013, which is incorporated in its entirety by this reference.

The Application is related to U.S. Provisional Application No. 61/710,867, filed on 8 Oct. 2012, U.S. Provisional Application No. 61/827,920, filed on 28 May 2013, U.S. Provisional Application No. 61/916,708, filed on 16 Dec. 2013, and U.S. Provisional Application No. 61/935,987, filed on 5 Feb. 2014, U.S. patent application Ser. No. 14/048,956, filed on 8 Oct. 2013, U.S. patent application Ser. No. 14/315,195, filed on 25 Jun. 2014, and U.S. patent application Ser. No. 14/315,195, filed on 25 Jun. 2014, all of which are incorporated in their entireties by this reference.

### TECHNICAL FIELD

This invention relates generally to the field of digital health, and more specifically to a new and useful method for providing real-time health-related advice in the field of digital health.

### BRIEF DESCRIPTION OF THE FIGURES

FIG. 1 is a flowchart representation of a method;

FIG. 2 is a flowchart representation of one variation of a first method;

FIG. 3 is a flowchart representation of one variation of the first method;

FIG. 4 is a schematic representation in accordance with one variation of the first method;

FIG. 5 is a flowchart representation of one variation of the first method;

FIG. 6 is a graphical representation in accordance with one variation of the first method;

FIG. 7 is a graphical representation in accordance with one variation of the first method; and

FIG. 8 is a flowchart representation of a second method;

FIG. 9 is a flowchart representation of one variation of the first method; and

FIG. 10 is a flowchart representation of one variation of the first method.

### DESCRIPTION OF THE EMBODIMENTS

The following description of the preferred embodiment of the invention is not intended to limit the invention to these preferred embodiments, but rather to enable any person skilled in the art to make and use this invention.

### 1. First Method

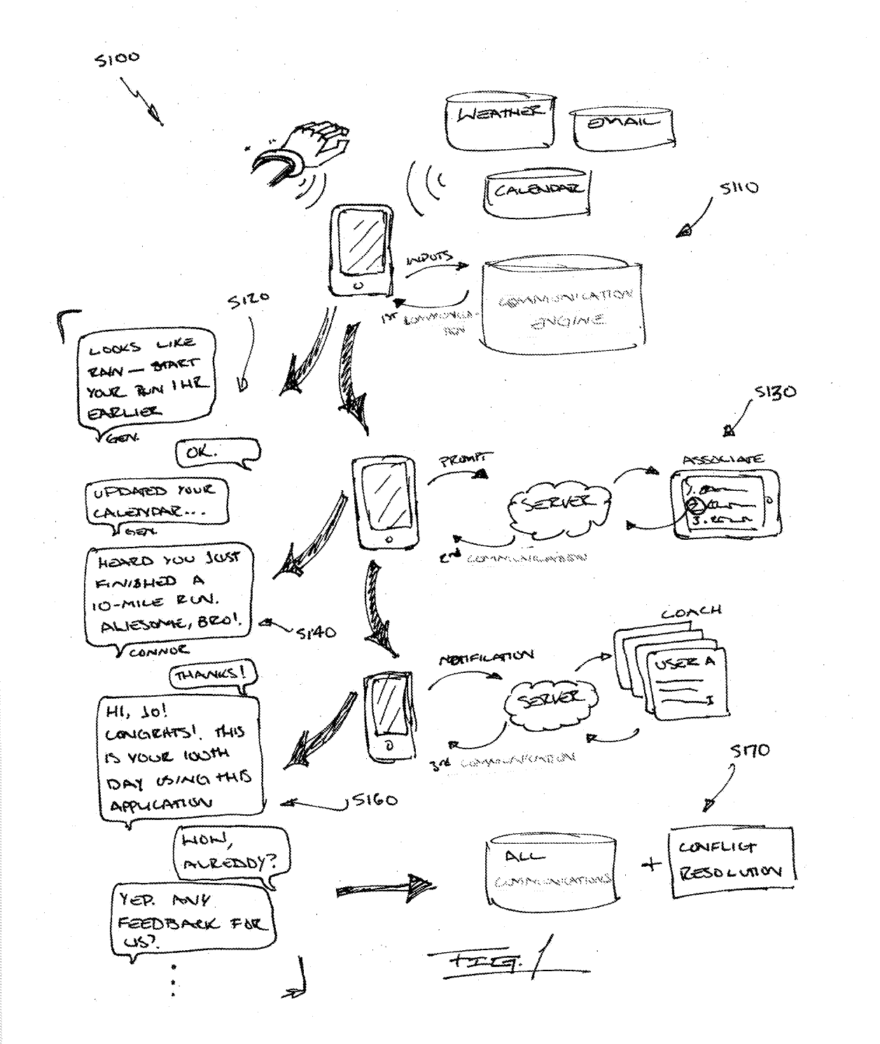

As shown in FIG. 1, a first method S100 for providing wellness-related communications to a user includes: applying a rule to environmental data and user data to generate a first communication in Block S110, the rule associated with a wellness application selected within a user's wellness account; displaying the first communication in a conversation feed in Block S120; prompting an associate of the user to select a second communication from a pre-populated list of communications in Block S130; displaying the second communication in the conversation feed in Block S140; notifying a human coach to communicate with the user in Block S150; displaying a third communication in the conversation feed in Block S160, the third communication entered by the human coach; and filtering communications in the conversation feed according to an estimated current relevance of the user in Block S170.

As shown in FIGS. 1 and 4, one variation of the first method S100 includes: applying a record of activity events performed by the user over a period of time to a communication engine to generate a first communication for the user in Block S110, the communication engine supported within a native wellness platform application executing on a computing device affiliated with the user; displaying the first communication within a textual conversation feed within the native wellness platform application in Block S120; receiving a response to the first communication from the user through the textual conversation feed in Block S120; correlating the response with a human involvement trigger in Block S150; based on the human involvement trigger, prompting a human coach to communicate with the user in Block S150; and displaying a second communication within the textual conversation feed in Block S160, the second communication entered by the human coach.

Similarly, as shown in FIGS. 1 and 4, another variation of the first method S100 includes: applying a record of activity events performed by the user over a period of time to a communication engine to generate a first communication for the user in Block S110, the communication engine supported within a native wellness platform application executing on a computing device affiliated with the user; displaying the first communication within a textual conversation feed within the native wellness platform application in Block S120; receiving a response to the first communication from the user through the textual conversation feed in Block S120; correlating the response with a human involvement trigger in Block S150; within the textual conversation feed, prompting the user to communicate with a human coach in Block S150; in response to receipt of confirmation to communicate with a human coach from the user, connecting the computing device to a communication device affiliated with a human coach in Block S160; applying a communication between the user and the human coach to the communication engine to select a second communication for the user in Block S110; and displaying the second communication within the textual conversation feed in Block S120.

### 1.1 Applications

Generally, the first method S100 supports conversation-reminiscent textual communications between a user and a behavior change engine, an associate of the user, and a human coach by monitoring the user and prompting and/or generating communications for the user according to current user wellness needs. For example, the first method S100 can monitor the user's adherence to a wellness (e.g., fitness, diet, stress) plan through access to automatically-recorded user motion data, manually-entered user data, user data accessed from a remote server, etc. In this example, the first method S100 can automatically (e.g., through artificial intelligence) generate communications for the user throughout a normal course of the wellness plan and automatically trigger a family member or friend of the user to create or select a communication if user data suggests that the user needs additional support to stay on track. The first method S100 can also automatically trigger a human coach (e.g., a human representative of a wellness partner hosting a wellness plan within a wellness application selected by the user within his wellness account) to send a communication to the user if the user is struggling with the wellness plan (e.g., has gone off track or ‘fallen off the bandwagon’) or has paid for a premium subscription to the wellness plan. The first method S100 can thus communicate textual communications (and/or messages including other content or media) from various sources to the user through a conversation channel specific to the wellness plan. The first method S100 can publish communications (i.e., messages) to a textual conversation feed (e.g., a chat-style message board) within the user's account, which can be accessed by the user through a native application executing on a mobile computing device (e.g., a smartphone, a tablet, etc.) and/or through a web browser executing on an Internet-connected device, to thus guide and support the user through a user-elected wellness plan.

The first method S100 can therefore enable substantially seamless transitions between automated communications, communications entered by an associate (e.g., friend, relative) of the user, and/or communications entered or otherwise provided by a human coach by selecting connecting the user's wellness account to corresponding resources and publishing communications supplied by these resources (related to a particular wellness program) into a single communication channel specific to the particular wellness program. The first method S100 can thus generate, prompt, and/or handle communications (e.g., reminders, feedback, support, guidance, empathy messages, etc.) for a particular wellness program and publish these communications within a single (textual or other) conversation feed regardless of the origin of each communication (e.g., automatically, semi-manually, or manually generated), thereby providing the user with a convenient stream of communications for a particular wellness program within a single digital location.

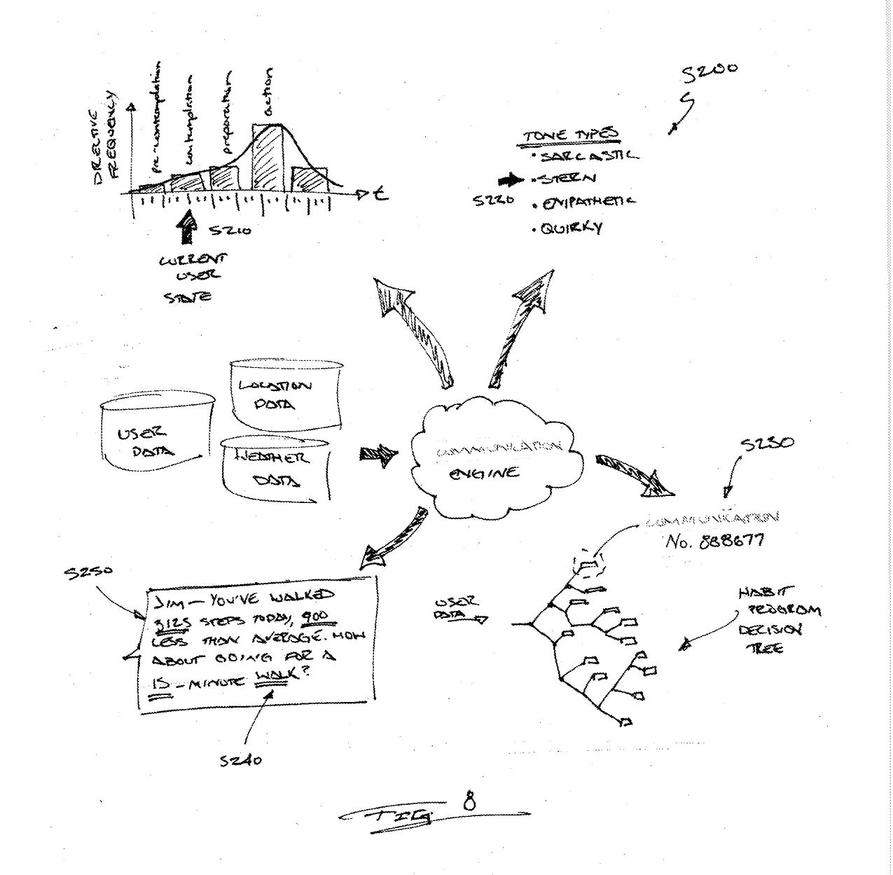

The first method S100 can also enable two-way communication between the user and any of a human (i.e., “live”) coach, an associate of the user, and/or a computer system (e.g., “artificial intelligence”) that generates the communications, as shown in FIG. 6. For example, the first method S100 can enable Block S110 to generate a first communication, Block S120 can publish the first communication through the conversation feed, the user can respond to the first communication by entering a textual response to the first communication, the first method S100 can repeat Block S110 to select a subsequent communication that responds to the user's textual response, and the first method S100 can repeat Block S120 to post the subsequent communication to the conversation feed for review by the user. For example, Blocks S110 and S120 can cooperate to apply the user's response and content of the first communication to the communication engine to select a second communication for the user and to then display the second communication within the textual conversation feed for the user. Within the same conversation feed, the first method S100 can also enable the user to communicate with an associate and/or to a human coach. For example, Block S150 can connect the user with a human coach based on the user's response to a communication generated automatically in Block S110. For example, Block S150 can engage the human coach to provide custom (e.g., manually-generated) textual communications for delivery to the user, and Block S160 can render these communications from the human coach within the textual conversation feed. Similarly, Block S150 can engage the human coach to select a textual communication from a list of available textual communications for delivery to the user in response to the user's response to a previous communication. Alternatively, Block S150 can engage the human coach to communicate with the user via telephone, via email, via an external messaging (e.g., instant messaging) service, in an in-person meeting, etc. Blocks of the first method S100 can collect data related to the subsequent user's interaction with the human coach and apply these data to the communication engine to automatically select a third communication for the user and to display the third communication within the textual conversation feed for the user. The first method S100 can therefore enable two-way responsive communication between the user and an automated communication generator (e.g., a communication engine of a wellness application, artificial intelligence), an associate, and/or a human coach.

### 1.2 Wellness Platform

The first method S100 can be implemented within a wellness platform supporting wellness applications hosted by various wellness partners. The wellness platform can enable independent health-, fitness-, and wellness-related entities (i.e., partners), such as a health insurance company, a diet program, a weight-loss system, a stress manager, a sleep program, a sports team, a college campus, a food vendor or grocer, a training program, a gym, etc., to provide an independent wellness application for various users. For example, the first method S100 can apply user data collected over time (e.g., in the form of a record of user activities) to a communication engine—such as corresponding to a wellness application affiliated with a third-party service, selected by the user, and hosted within the native wellness platform application executing on the user's computing device—to generate timely wellness-related communications for the user.

The first method S100 can thus receive and/or record user and environmental data, retrieve a communication engine defining a set of rules for generating and handling communications with the user and corresponding to a wellness application elected by the user, apply the set of rules to user and/or environmental data to generate communications (e.g., reminders, feedback, directives) for the user over time, and render various communications thus generated within a conversation feed for review by the user. For example, the first method S100 can apply a set of rules (e.g., in the form of an algorithm, a parametric model, or a non-parametric model specified by a particular wellness application) to various inputs to select and/or generate textual communications to guide and support the user through a wellness program. The first method S100 can also apply the set of rules to user activity and/or environmental data to trigger an interaction from an associate (e.g., a friend, a family member) of the user and/or from a human coach to provide additional (human) empathy, support, and/or guidance to the user throughout the wellness program.

As shown in FIG. 7, the wellness platform (e.g., the native wellness platform application) can support wellness applications in various wellness categories, such as fitness, exercise, stress, sleep, and/or diet. For example, the wellness program can support an independent diet program that defines rules to aid the user in consuming particular foods at certain times, an independent ‘marathon’ program that defines rules to aid the user in training for a marathon, an independent stress manager that defines rules to aid the user in reducing stress, an independent gym that defines rules to aid the user in losing weight, and/or an independent sleep program that defines rules to aid the user in getting enough sleep and managing sleep cycles. The wellness program can also support multiple wellness applications in various wellness categories (e.g., sleep, exercise, diet, etc.). For example, the wellness program can support multiple diet-related wellness applications, such as one or more ‘low-carb’ diet programs, juice-only diet programs, vegan diet programs, gluten-free diet programs, etc. The wellness program can thus enable a user to select a particular diet program, sleep program, and/or stress program, etc. that is/are of particular interest or particularly applicable to the user. The first method S100 can further distribute timely communications from these various resources to particular communication channels to guide and support the user through a each selected wellness program.

The wellness platform can enable the user to create, maintain, modify, and grow a wellness account (e.g., a wellness profile), such as a private wellness account accessible through a native wellness platform application executing on a smartphone or accessible through a web browser, as described below. The wellness platform can also enable the user to add multiple wellness applications from one or more wellness categories to his wellness account. For example, the first method S100 can enable the user to select one wellness application for a particular sleep program and one wellness application for a particular diet program. The first method S100 can also enable the user to select multiple wellness applications in one wellness category, such as a yoga application and a weightlifting application, both of which may fall under a fitness category.

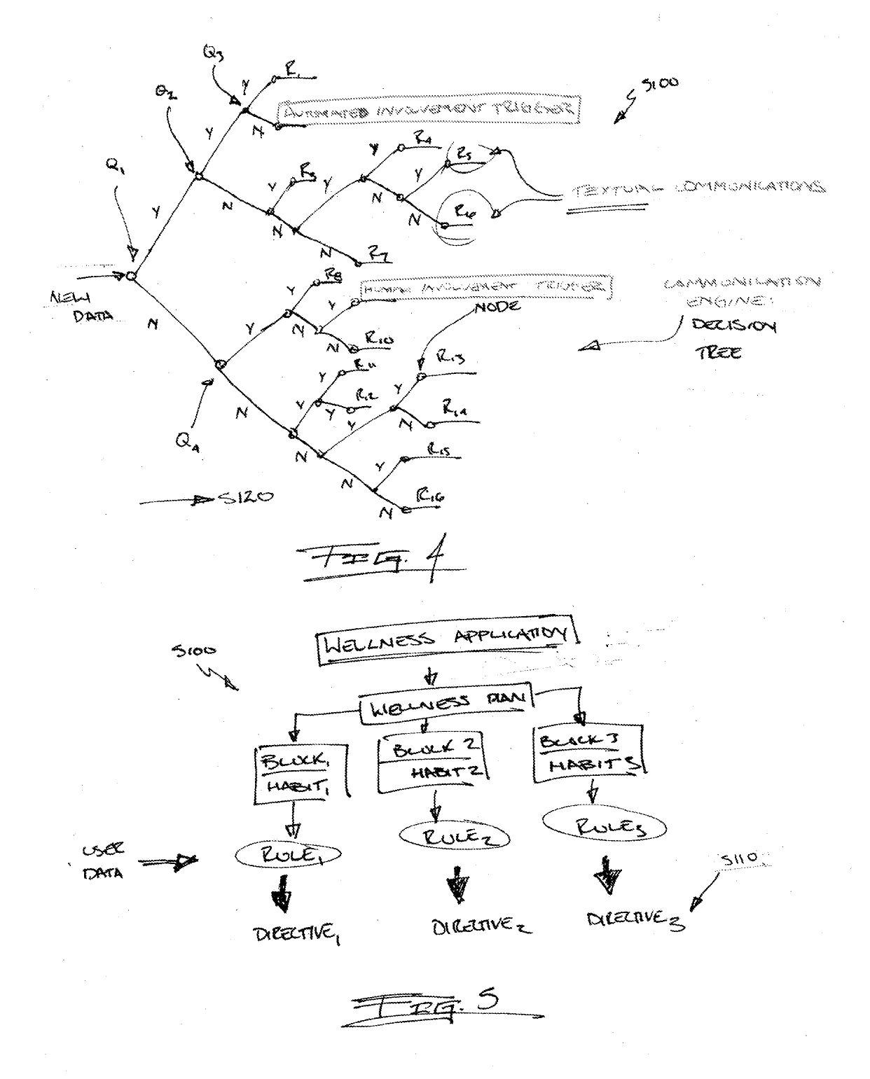

As shown in FIGS. 1 and 3, each wellness application supported by the wellness platform can define rules to manipulate user activity and/or environmental data to output coaching-type communications in particular wellness areas (or wellness categories) for the user. Each wellness application can also define triggers, pre-populated messages lists, and/or conversation feeds, etc. to enable external parties (i.e., an associate, a human coach) to deliver a textual communication to the user. Each wellness application can be associated with a particular wellness goal, such as weight loss, stress management, an exercise achievement (e.g., completing a marathon), etc., and each wellness application can provide custom automated and human coaching services and content to a user through the wellness platform.

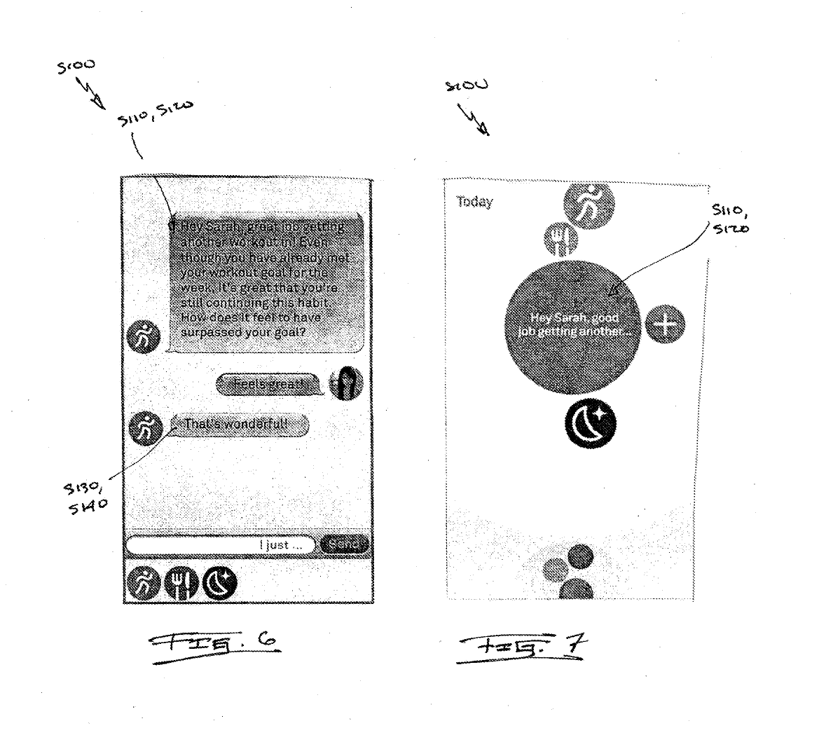

As shown in FIG. 5, a wellness application supported by the wellness platform can specify a wellness plan, such as a diet plan or a workout plan. The wellness plan can define a highest-level container of rules associated with a user's wellness goal. The wellness plan can include multiple blocks (e.g., time blocks), wherein each block defines one or mode habits to create (or modify or eliminate). The wellness plan can therefore include multiple habits such as major habits (e.g., a diet-related habit, an activity-related habit) and minor habits (e.g., a sleep-related habit, a mood-related habit). The wellness plan can therefore define a step-by-step program, and the user can progress through the wellness plan by achieving one block and moving to subsequent blocks of the wellness plan. The first method S100 (e.g., Block S130) can apply rules specified by a habit in a current block to generate a reminder to perform an action to achieve the habit and/or to generate feedback for a recent user action or inaction pertaining to the habit. For example, in a first weeklong block of the wellness plan, Block S130 can output a reminder to “log all meals,” and, in a second weeklong block of the wellness plan, Block S130 can output a reminder to “log two vegetables per day.” The user can also be engaged in multiple blocks within one wellness application simultaneously, such as one habit program (e.g., habit block) that builds on another habit program.

### 1.3 Computer System Executing the First Method S100

The first method S100 can be implemented within a native application (e.g., a native wellness platform application) executing on a mobile electronic device carried by the user (e.g., a smartphone, tablet, smart watch, smart glasses, or other mobile computing device). In particular, the first method S100 can be implemented as a native application that supports multiple internal wellness applications to guide and/or improve user wellness. Alternatively, the first method S100 can be implemented as a user interface or a user dashboard accessible through a web browser executing on a computer or through any other suitable electronic device or (audible, visual, and/or tactile, etc) user interface. Yet alternatively, the first method S100 can be implemented on one or more computer systems, such as a cloud-based computer system, a mainframe computer system, a grid-computer system, or any other suitable remote computer system. For example, the first method S100 can be implemented by a remote cloud-based computer system (e.g., remote server) in communication with a smartphone carried by the user, wherein the computer system implements the first method S100 to select or generate a communication and transmits the communication to the smartphone where the communication is displayed for the user (e.g., with a textual conversation feed within the native wellness platform application). However, the first method S100 can be implemented by or in cooperation with any other one or more mobile computing devices, processors, computers, computer networks, etc.

As shown in FIG. 3, the first method S100 can therefore interface with various hardware and/or software systems. For example, the first method S100 can interface with a wristband (or other wearable device) incorporating an accelerometer, a gyroscope, a temperature sensor, and/or a display, such as the wristband described in U.S. Provisional Application No. 61/710,867. In this example, the first method S100 can receive user motion, temperature, and/or other user-related data as the user wears the wristband during each day and/or at night. Block S110 can similarly interface with external devices, such as a bath scale or a digital environment thermometer, to retrieve additional user or local environmental data. The first method S100 can also interface with (or be implemented on or through) a mobile computing device (e.g., a smartphone) incorporating a GPS sensor, communication channels (e.g., email, SMS text messaging), and a display, etc., to collect relevant user data over time. The first method S100 can additionally or alternatively interface with an email server to track user communications, with a computer or other multimedia device to track user media consumption, with a cloud-based calendar to track the user's schedule, with a weather database to track local weather or environmental conditions, with a social network to identify user relationships and/or track another form of user communications, with a hospital database to retrieve and/or update user health records, etc. the first method S100 can therefore receive and/or aggregate various user and environment data from multiple sources and, and Block S110 can implement this data, respective of one or more selected wellness applications, to output or generate a communication for the user.

In one implementation, the first method S100 is implemented on (or the communications displayed through) a native wellness platform application executing on a mobile computing device (e.g., a smartphone, a tablet, smart glasses with a heads-up display, a smart watch, etc.), and Block S110 collects data through sensors arranged within the mobile computing device. For example, the first method S100 can collect: the user's location and a timestamp for the location through a GPS sensor arranged within the mobile computing device; a rate and timing of email sent and received by the user; SMS text messages sent and received by the user; and phone communications made and received by the user at the mobile computing device; a user's calendar schedule; and a rate and timing of the media consumption by the user on the mobile computing device; etc. through associated native applications executing on the mobile computing device. In this implementation, the first method S100 can also interface with one or more wearable devices to collect user data, such as by communicating wirelessly with a wristband fitness monitor (shown in FIG. 1)—through the mobile computing device—to retrieve user motion (e.g., accelerometer and/or gyroscope) data. The first method S100 can further interface with a database, a remote server, and/or a computer network, such as via an Internet connection, to retrieve user calendar information, rate and timing of textual communications (e.g., email), user hospital and/or health records, user access to a social networking system, local weather and environmental data, local food and/or grocery options, local trending or available activities, etc. and merge these disparate data into a record (or stream) of activity data. For example, the first method S100 (e.g., Block S110) can collect a first set of action data of the user from a wearable device worn by the user during the period of time, collect a second set of action data of the user from a mobile computing device associated with the user during the period of time, and fuse the first set of action data and the second set of action data into discrete activity events performed by the user during the period of time.

However, the first method S100 can collect various user and/or environmental data in any other suitable way.

### 1.4 Automated Communications

Block S110 of the first method S100 recites applying a record of activity events performed by the user over a period of time to a communication engine to generate a first communication for the user, the communication engine supported within a native wellness platform application executing on a computing device affiliated with the user. (Block S110 can similarly recite applying a rule to environmental data and user data to generate a first communication, wherein the rule is associated with a user-elected wellness application within the user's wellness account.) Generally, Block S110 functions to implement one or more rules defined by a user-elected wellness application to generate a timely communication for the user, such as a reminder to perform a future action and/or to generate timely feedback for the user in response to a recent user action, new user data, and/or new environment data. Block S110 can therefore function to implement artificial intelligence to automatically generate a communication for the user, such as based on an algorithm and machine learning methods defined in a corresponding wellness application.

In one implementation, the wellness application includes a pre-populated list of communications, and Block S110 generates a communication by selecting a communication from the pre-populated list of communications. In one example shown in FIG. 4, each wellness application can define a decision tree with a complete textual communication defined at each node in the decision tree, and Block S110 can move through branches of the decision tree according to user and/or environmental data (substantially in real-time as user and/or environmental data is collected or received) to select a particular node and to elect a particular communication for the user. In a similar example, the wellness application can define a decision tree with a template (or “form”) communication defined at various nodes therein, and Block S110 can move through branches of the decision tree according to user data, environmental data, and/or a previous response entered into the conversation feed by the user to select a particular node within the decision tree, to elect the template communication defined at the particular node, and to then complete the form communication with relevant user and/or environmental data. In particular, in this example, Block S110 can: pass data from the record into the decision tree to select a first node from a set of nodes defined within the decision tree (wherein the communication engine includes the decision tree); select a first template communication, from a set of template communications, corresponding to the first node; and then customize the first template communication with data from the record to generate the first communication. In the foregoing examples, the wellness application can include one decision tree for all blocks, one decision tree per block or habit, or any other number of decision trees. The wellness application can include a similar decision tree(s) for feedback, and Block S110 can apply similar methodology to select or generate feedback.

The wellness application can also define a decision tree that is specific to a particular period of time, such as a day of the week or a particular week within a wellness program, or relevant to an arbitrary period or length of time. However, Block S110 can generate and/or select a communication and/or feedback in any other suitable way.

In the foregoing implementation, a decision defined within the wellness application can include nodes specifying triggers to involve a human (e.g., a “human involvement trigger”) with the user. As described below, Block S110 can navigate through the decision tree, based on user activity data, local environmental data, and/or a previous response entered into the conversation feed by the user, and Block S150 can initiate communications between the user and another human in response to selection of a node—from the decision tree—defining a human involvement trigger, such as described below.

Generally, as shown in FIGS. 1, 6, and 7, the first method S100 can elect and/or generate a communication (e.g., a directive, a reminder, an empathy message, etc.) to serve a habit-building action to the user, such as based on a block currently engaged by the user within a wellness application. In one example, for a diet-related wellness application in which the user is currently engaged in a food preparation habit-building block, Block S110 can apply user location data to select a communication to prompt the user to purchase a particular foodstuff when the user is within a threshold distance of a grocer. In another example, for a marathon training wellness application in which the user is currently engaged in a daily ten-mile training block, Block S110 can apply current and forecast weather data to select a communication to prompt the user to begin a scheduled run one hour earlier than scheduled to avoid a forecast rainstorm. Therefore, Block S110 can generate communications including timely content and then serve these communications at particularly relevant time, such as when the user is in or near a particular location or about to engage in a particular related activity.

In various examples, Block S110 can select a communication that includes any of the following: 1) “You're 300 calories short of your calories burned goal, walk to the Giants game instead of taking a cab . . . don't worry, you'll make it!” 2) “Hey, your average walk to work is 12 minutes. Why not try to beat your best time and do it in 11?” 3) “It's going to rain in one hour, so let's get that run in right now!” 4) “The weather has changed unexpectedly, and that run doesn't look like it's going to happen. Hit the local gym on 24th street and do your interval sessions on the treadmill.” 5) “Hey, good morning. Here's your workout plan for the week. I'll ping you to remind you to get your gym clothes.” However, Block S110 can generate or select any other communication including any other suitable content.

Therefore, Block S110 can automatically select feedback that functions to serve habit reinforcement, encouragement, and/or empathy to the user in response to a user action and/or inaction. Block S110 can select or generate feedback based on a block currently engaged by the user and/or based on new user data and/or new environmental data. As in the foregoing example in which the user is currently engaged in a food preparation habit-building block of a diet-related wellness application, Block S110 can determine that the user entered the grocer in response to the related communication, prompt the user to confirm purchase of the particular foodstuff, and select feedback that includes a recipe for the foodstuff for the user as reward for completing the communication. Furthermore, as in the foregoing example in which the user is currently engaged in a daily ten-mile training block within a marathon training wellness application, Block S110 can analyze accelerometer data from a wristband to determine that the user is running and select feedback congratulating the user for completing the run before the forecast rain time. Therefore, Block S110 can select or generate feedback including content that is appropriately served to the user after a particular activity or inactivity.

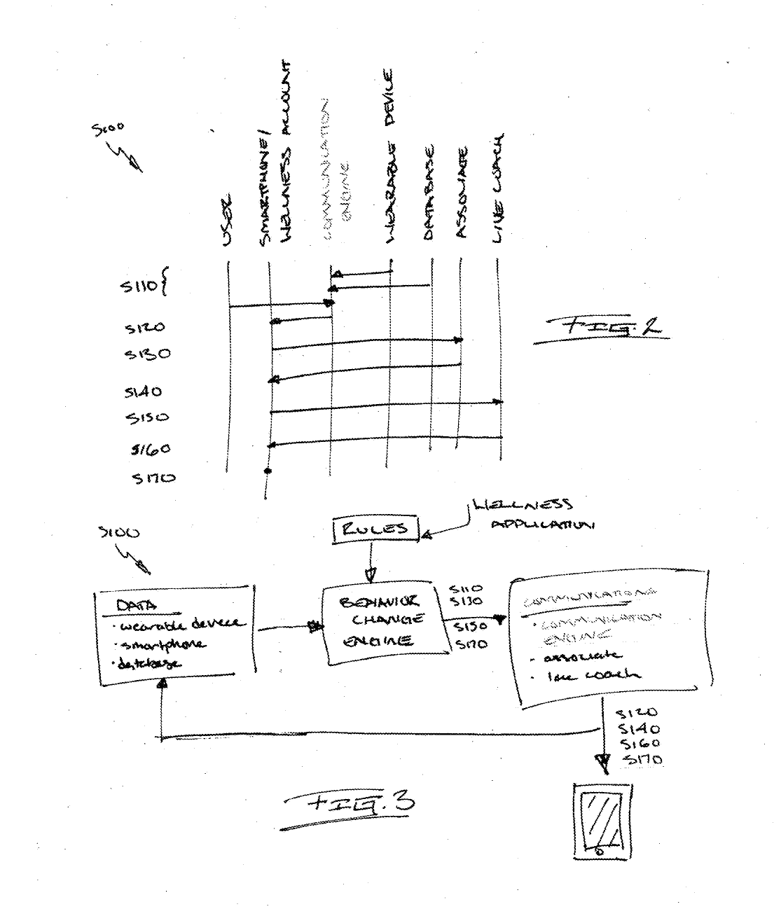

As shown in FIGS. 1 and 2, Block S110 can therefore analyze raw sensor data to determine (e.g., estimate, predict) a user action. In one implementation, Block S110 implements pattern recognition to analyze accelerometer and/or gyroscope data from a wristband worn by the user (or a smartphone carried by the user) and automatically identifies user actions (or activities) in the data based on classifications of recognized motion patterns. For example, Block S110 can analyze raw three-dimensional accelerometer data to count the user's steps. Block S110 can similarly analyze accelerometer data to classify biking, running, walking, and Block S110 can further analyze gyroscope data to determine that the user is playing tennis or basketball or is swimming (and the user's type of stroke). For motion data recorded through a wristband sensor, Block S110 can also determine that the user is eating by characterizing repetitive motion between a plate position and a mouth position, and Block S110 can further apply user location data, check-ins, calendar events, social networking system communications, etc. to determine where (and therefore what) the user is eating. Block S110 can also determine if the user is sedentary, such as based on lack of accelerometer outputs exceeding a threshold acceleration along at least one axis within a period of time, and Block S110 can also determine if the user is sleeping and a current user sleep cycle, such as described in U.S. Provisional Application No. 61/710,867.

In various examples, Block S110 can select feedback that includes any of the following: 1) “Hey—great tennis you played there! It got you to your daily goal. Would you like us to remind you the same time next week to do a workout?” 2) “You had your best workout listening to these songs, this genre . . . do you want your music player to curate another playlist for tomorrow's workout?” 3) “This is your third workout this week, and it was the most intense. Great job. Aim for another cardio workout in two days for optimal calorie burning.” 4) “You spend five hours of your workday completely sedentary. That's way above average. Taking a walking break now would break up the day and could get you to your daily step goal.” 5) “You burn the most calories on Thursdays, and the least on Wednesdays, so let's up your Wednesday count by doing a fifteen-minute walk now.” 6) “You're a workout pro. You worked out four times a week and burned 450 calories on average. You're rocking it!” 7) “You're 500 steps short of your daily steps goal, but grocery shopping is on your calendar and is a great way to get these last steps in before the end of the day.” 8) “Hey, you ran at a faster pace today! It might have been because of the lower ambient temperature. See how the ambient temperature over the past few day has impacted your performance.” However, Block S110 can generate or select any other feedback including any other suitable content.

As described above, Block S110 can also select or generate content that includes a combination of a reminder and feedback. Block S110 can also generate or select multiple communications substantially simultaneously, such as if the user has added multiple wellness applications to his wellness account.

Block S110 can apply one or more schema to trigger generation of the first communication. In one implementation, Block S110 generates the first communication in response to new user and/or environmental data according to a rule defined by a wellness program, as described above. In another implementation, Block S110 generates the first communication in response to receipt of a content entered manually by the user. For example, without prompting by the native wellness platform application, the user can enter or select a message (e.g., from a pre-populated list of messages) to submit to his native wellness platform application, such as by selecting an “I'm bored” message from a list of available messages or by typing “I'm about to eat a cupcake—help me!” into an text field within the textual conversation feed within the native wellness platform application executing on the user's mobile computing device. Block S110 can thus respond to the user's message by generating the first communication, and Block S120 can display the first communication within the textual conversation feed to continue the textual conversation with the user. (Blocks S130 and S150 can similarly prompt an associate and a human coach, respectively, to respond to the user following receipt of a message entered or selected by the user at will.) However, Block S110 can function in any other way to apply a rule to environmental data and/or user data to generate a communication for the user.

Block S110 can further include: retrieving a user preference for tone of communications delivered to the user; select a template communication for delivery to the user based on the record of activity events; and then customize the template communication into the first communication based on the user preference for tone, as described below. Similarly, Blocks S110 determine a level of engagement of the user in a wellness program hosted within the native wellness platform application based on the record of activity events, define a trigger for delivery of the first communication to the user, and set a maximum frequency of communications to the user within a period of time based on the level of engagement; and Block S120 can then display the first communication within the textual conversation feed in response to detection of the trigger in the record of activity events based on a number of communications rendered within the textual communication feed within a current period of time falling below the maximum frequency of communications, such as described below.

Block S120 of the first method S100 recites displaying the first communication within a textual conversation feed within the native wellness platform application. Generally, Block S120 functions to publish a first communication generated automatically (e.g., through artificial intelligence) in Block S110. In one implementation, Block S120 publishes the first communication in a chat-style textual messaging window within the user's wellness account. For example, Block S120 can publish the first communication to a private message board within a native application that executes on a mobile computing device. In this example, Block S120 can also push a notification, including the first communication, to the mobile computing device, and Block S120 can direct the user to a chat-style window specific to a respective wellness program within the native wellness platform application in response to selection of the notification. Block S120 can similarly publish the first message within the user's wellness account such that the message is accessible from various computing devices, such as a tablet, a smartphone, a desktop computer, etc. executing instances of the native wellness platform application and/or a web browser accessing the user's account. Block S120 can therefore present the first communication to the user through a user interface within a native application executing on a mobile computing or wearable device or through a dashboard accessible through a web browser on a computing device.

In another implementation, Block S120 can publish the first communication to an independent messaging application (e.g., an SMS text messaging application) executing on the user's mobile computing device. In this implementation, Block S120 can push the first communication to a particular ‘contact’ channel within the independent messaging application, and Block S140 and Block S160 similarly publish the communication from an associate and a human coach, respectively, to the same contact channel. However, Block S120 can post a communication—automatically generated in Block S110—within any other suitable conversation feed accessible by the user to review such communications.

As described above, the textual conversation feed can enable two-way responsive communication between the user and the communication engine (of Block S110). In one example, Block S110 can compare user motion data collected through a wearable sensor (e.g., a wristband with integrated accelerometer) to a fitness goal specified in a user-elected fitness application to determine that the user has met his fitness goal. In this example, Block S110 can generate the first communication that includes, “Hey Sarah, great job getting another workout in! Even though you have already met your workout goal for the week, it's great that you're still continuing this habit. How does it feel to have surpassed your goal?” as shown in FIG. 6. In this example, Block S120 can publish the first communication within the conversation feed, and the user can respond to the first communication, such as by typing and submitting the phrase “Feeling great!” Block S120 can then implement natural language processing to characterize the user's manual entry of related wellness information; Block S110 can thus repeat methods and techniques described above to select a suitable second communication to the user's response—such as “That's wonderful!”—and Block S120 can publish the second communication to the conversation feed to provide additional information, support, and/or guidance to the user, as shown in FIG. 6. However, Block S110 and S120 can cooperate in any other way to collect a user response to the first communication, to apply the user's response to generation of a suitable response, and to provide the response to the user through the conversation feed.

Block S120 can additionally or alternatively present communications to the user as pop-up messages notifications, emails, SMS text messages, independent native application messages (as shown in FIG. 7), or any other suitable type of textual communication, such as through a mobile computing device, a wearable device, etc. associated with the user. Block S120 can also present visual and/or audible communications to the user. Block S120 can similarly communicate video, music, calendar updates, progress screens, or other media related to a wellness application to the user.

In one implementation, Block S120 interfaces with an intelligent personal assistant (e.g., a mobile software agent) executing on a smartphone (or other mobile computing device) affiliated with the user to present communications to the user through a voice emulator. For example, Block S120 can emulate a human and host two-way oral communication between the user and the user's wellness account through the intelligent personal assistant. In particular, in this example, Block S120 can interface with an external intelligent personal assistant installed on the mobile computing device to audibly present communications to the user and to receive verbal responses to the communications from the user, thereby enabling the user to interact with the system in a back-and-forth verbal conversation, the system thus providing and receiving communications and details pertaining to a wellness plan, user- and/or program-specified goals, habits, user actions, user needs, user interests, user questions, etc. Blocks S140 and S160 can similarly interface with the intelligent personal assistant (executing on a mobile computing device or other device) to present audible communications to the user through a voice emulator and/or to receive spoken responses to communications such from the user.

Therefore, Block S110 and Block S120 function to generate and deliver timely communications to the user, respectively, to assist the user through a wellness program. Communications thus handled in Blocks S110 and S120 can be substantially generic, selected from a pre-populated list (e.g., a decision tree) of communications specified by a user-elected wellness program, and/or customized based on the user's progress through the wellness program, such as based on a current habit program within the wellness program. However, Block S110 and Block S120 can function in any other way to generate and post communications for the user.

### 1.5 Human Involvement Trigger

As shown in FIG. 4, one variation of the first method S100 includes correlating a response from the user with a human involvement trigger. Generally, as described above, the first method S100 can analyze a response supplied by the user into the textual (or oral, etc.) conversation feed to identify a need or a trigger to transition from delivery of automatically-generated communications to the user to delivery of manually-generated communications to the user.

In one implementation, the first method S100: receives a textual response entered by the user into a text field within the textual conversation feed; categorizes the textual response as a particular response type; applies the particular response type to the decision tree to shift from a first node (such as corresponding to a communication previously presented to the user) to a second node within a decision tree of a current wellness application; identify a human involvement trigger from the second node; and then trigger Block S130 and/or Block S150 to initiate communication between an associate or a human coach, respectively, based on the human involvement trigger.

In the foregoing implementation, the first method S100 can thus implement natural language processing to identify—from a previous response submitted by the user—a need to involve a human entity in communicating with the user.

### 1.6 Associate Communications

One variation of the first method S100 includes Block S130, which recites prompting an associate of the user to select a third communication from a set of messages based on the human involvement trigger; and displaying the third communication with the first communication within the textual conversation feed. (Block S130 can similarly recite prompting an associate of the user to select a third communication from a pre-populated list of communications.) Generally, Block S130 functions to involve a human associate (e.g., a friend, a family member) of the user with the user's elected wellness program to provide additional (e.g., personal) guidance and/or empathy to support the user in achieving a goal (i.e., a habit program) within the wellness program.

Block S130 can prompt the associate to provide support to the user according to various trigger schemas. In one implementation, Block S130 prompts the associate to communicate with the user if the user fails to complete an action specified in a communication previous presented to the user (e.g., “walk 5000 steps today”). In this implementation, Block S130 can prompt the associate to communicate with the user if the user fails to fulfill actions specified in a threshold number of sequential communications or in a threshold number of communications within a period of time or within a block of the wellness program. For example, if Block S120 publishes a communication to eat two vegetables at lunch, the user indicates that he ate no vegetables at lunch, and Block S130 determines that the user has failed to complete a diet-related directive for three meals in a row, Block S130 can initiate involvement of the associate (e.g., to get the user back on track).

In another implementation, Block S130 can prompt the associate to communicate with the user if the user has exceeded a goal specified in a recent (e.g., previous) communication by a threshold magnitude. For example, Block S120 can publish a communication to “walk 5000 steps today before 6 pm,” the first method S100 can track the user's steps through a wearable device worn by the user, and Block S130 can initiate involvement of the associate (e.g., to congratulate the user) if the user's total step count before 6 pm exceeds 8000 steps.

In yet another implementation, Block S130 can initiate involvement of the associate with the user on a regular (e.g., timed) basis. In this implementation, Block S130 can inform the associate of the user's progress within the habit program to trigger the associated to communication additional personalized support to the user. However, Block S130 can trigger involvement of the associate in response to any other timing, communication, and/or user action, etc.

In another implementation, when the user first creates (or updates) his personal wellness account, the wellness account can prompt the user to enter a name and contact information for one or more human associates to support the user throughout various wellness applications engaged by the user. For example, the user can enter a name and contact information for a friend, a coworker, and a sibling. The wellness account can also prompt the user to set preferences or a priority for the list of associates. In the foregoing example, the user can set a contact preference for the friend followed by the sibling and then the coworker. one or more associates can be added to the user's wellness account and/or elected wellness application(s) in any other way. Thus, in response to detection of a human involvement trigger, Block S130 can sequentially prompt the user's associates (in order or preference or priority) to communicate with the user until one of the user's associates provides a timely communication to the user. However,

Once Block S130 identifies a need for associate involvement in the user's wellness program, Block S130 can thus push a prompt to communicate with the user to a particular associate noted in the user's wellness account and/or in a particular wellness application engaged by the user. In one implementation, Block S130 initially sends the prompt to the user's preferred associate and assigns a time window for the associate to respond to the prompt. If the preferred associate fails to respond to the prompt within a specified period of time (e.g., two minutes), Block S130 can push a prompt to an alternative (e.g., a second preferred) associate. Block S130 can thus move through each user-entered associate until a response is submitted to the prompt. Block S130 can also alter the requisite response time to a prompt before moving to a subsequent associate, such as by increasing the response time (e.g., by 50%) for each subsequent associate. Block S130 can additionally or alternatively select the associate based on the associate's proximity to the user. For example, Block S130 can first select an associate who is nearest the user (e.g., four blocks away), such as if the prompt suggests that the associate and the user meet to achieve one of the user's a wellness goals.

In one implementation, Block S130 pushes the prompt to the user's associate in the form of an SMS text message accessible through a SMS text messaging application to an address affiliated with the associate. In this implementation, the prompt can include a description of the user's current wellness status and a prompt to provide guidance, empathy, support, etc. to the user based on the user's current wellness status and/or recent record of activity events. In one example, if the user recently exceeded a goal to complete 5000 steps in one day as specified in a fitness application, Block S130 can generate a message that includes “Jim walked 7000 steps today, which is a lot more than his daily goal of 5000. Want to congratulate him? (This offer will self-destruct in 60 seconds).” In another example, if the user has been too sedentary over a period of time, as determined from limits defined by the fitness application, Block S130 can push a prompt reciting, “Jim has been pretty sedentary today—want to see if he has time for a walk to a local coffee shop?” to an associate within walking distance of the user. In this implementation, Block S130 can enable the associate to respond to the prompt by submitting a SMS text message through the SMS text messaging application, and Block S140 can publish the associate's response to the conversation feed for the related wellness application for review by the user. As in the former example, Block S140 can collect a response from the associate (e.g., “Way to go, Jim!”) through the SMS text messaging application and push the response into the conversation feed associated with the fitness application for the user. As in the latter example, Block S140 can collect a response from the associate that includes “Jim, time to get on your feet—how about coffee at Cait's Café in 20?” and push the response into the conversation feed associated with the fitness application.

Alternatively, Block S130 can push the prompt to the user through a native wellness application executing on the associate's mobile computing device. In this implementation, the first method S100 can thus create a network of users associated with wellness accounts, and Block S130 can prompt communication between users within the network to enable personalized support amongst users within the network, such as amongst users engaged in the same wellness programs. Block S130 can therefore communicate a prompt to an associate of the user directly through a wellness account, such as through a notification pushed to an address (e.g., email address, phone number) affiliated with the associate. In this implementation, Block S130 can prompt the associate to enter a custom textual message (i.e., a custom textual communication). Alternatively, Block S130 can prompt the associate to select a particular message from a pre-populated list of available messages for the user. For example, Block S130 can generate a prompt including a description of the user's current wellness status, five possible messages, and a direction to select one of the five possible messages and then transmit this prompt to the selected associate. In this example, Block S130 can select the pre-populated list of available messages based on the user's current wellness status, mood, local weather conditions, and/or any other suitable user and/or environmental data. However, Block S130 generate and push a prompt including any other information or message to one or more elect associates of the user through any other suitable communication channel.

In this variation, the first method S100 can also include Block S140, which recites displaying the third communication (from the user's associate) in the conversation feed. Generally, Block S140 implements any one or more techniques of Block S120 to push the associate's response to the prompt of Block S130 to the conversation feed of the respective wellness application. Block S140 can push the associate-elected communication to the conversation feed once received from the associate. Alternatively, Block S140 can withhold the third communication for a period of time once received from the associate, such as in anticipation of a future time at which the third communication may be more relevant to the user. For example, Block S140 can withhold the associate-elected communication until a user or environmental event defined by the wellness application occurs. Block S140 can therefore post associate-elected communications to the conversation feed in line with communications generated with the communication engine in Block S110.

Like Block S120, Block S140 can also receive a response to the third communication from the user through the conversation feed, and Block S130 and Block S140 can repeat to enable further communicate between the user and the associate through the conversation feed. Block S140 can therefore implement any of the first method S100s described above to enable two-way communication (i.e., a conversation) between the user and one or more associates of the user through the conversation feed. However, Block S140 can display the second (i.e., associate-elected) communication in any other way and/or according to any other timing or schema.

### 1.7 Human Coach Communications

Block S150 of the first method S100 recites correlating the response with a human involvement trigger and, based on the human involvement trigger, prompting a human coach to communicate with the user. (Block S150 can similarly recite notifying a human coach to communicate with the user.) Generally, Block S150 functions to identify a user need for involvement of a human coach and to notify the human coach accordingly. Block S150 can interface with a human coach associated with a particular wellness partner hosting a particular wellness application and can thus prompt a human coach to communicate with the user based on change in status of the user within the corresponding wellness program.

In one example, a diet-related partner can host a dietary application specifying a dietary program with a set of dietary habits within a set of weeklong habit blocks, and the diet-related partner can provide human coaches to offer additional personalized need-based support to users as the users progress through the dietary program. Block S150 can therefore interface with wellness partner-specific human coaches to guide the user through related wellness applications.

Generally, Block S150 can implement techniques similar to those of Block S130 described above to trigger a prompt to the human coach to communicate with the user. For example, if the user has failed to achieve actions specified in threshold number of communications (e.g., within a period of time, sequentially), Block S150 can identify a need to involve a human coach to boost the user's moral, to empathize with the user, and/or to provide targeted advice to guide the user ‘back on track’ to achieving a wellness-related goal. Block S150 can therefore notify the coach when communications from the automated communication generator and from the user's associate may be insufficient to motivate, inspire, and/or support the user through a particular wellness program or through a particular goal defined within a wellness program. The wellness program can further define triggers (e.g., rules) to initiate communication between a human coach and the user, such as based on current and/or trending user and/or environmental data.

Additionally or alternatively, Block S150 can prompt the human coach to communicate a congratulatory message to the user. For example, Block S150 can notify the coach to congratulate the user for fulfilling a directive of a respective wellness program, for completing a respective wellness program, for following a respective wellness program for a certain period of time (e.g., 100 days), etc. As in the foregoing example, Block S110, Block S130, and/or Block S150 can also track and respond to (e.g., reward) user ‘firsts,’ such as the first time the user consumed breakfast three days in a row, the first time the user surpassed 12,000 steps in one day, the user's 100^{th} day engaged in a wellness application or the wellness platform, etc.

In one implementation, the first method S100 executes Block S150 to provide human coaching services as part of a premium (e.g., paid) version of a wellness program. For example, a user who pays a discounted rate (or nothing) for a wellness program (e.g., a “freemium” version of the wellness program) may only receive communications from the automated communication generator and/or from select associates identified by the user. However, in this example, a user who pays a full rate for the wellness program (i.e., a “premium” version of the wellness program) may receive human coach communications in addition to communications from a communication engine and from the user's associates.

Block S150 can push an email, a SMS text message, an in-app notification, a notification within an electronic coaching interface or dashboard, or any other suitable type of electronic notification to the human coach. For example, the human coach can open a coaching dashboard within a web browser or native application to provide coaching communications (e.g., feedback) to the user. The dashboard can display multiple wellness accounts for one or more users (e.g., substantially simultaneously), can display relevant user data (e.g., user data pertaining to a respective wellness application, user activity records), and can receive communication selection or manual entry of a communication from a human coach, and Block S160 can push the coach's (selected or manually-entered) communication to the user's conversation feed, such as in line with the first and third communications described above. For example, the first method S100 can select a subset of data from the record of activity events of the user and transmit the subset of data and the user's response to the human coach's communication device in response to receipt, from the user, of confirmation to communicate with the human coach (as described below), and Block S150 can present these data to the elected human coach and then cooperate with the Block S160 to present to the user a communication thus elected or generated by the human coach based on the subset of user activity data.

Block S150 can also prompt the human coach to communicate with multiple users, such as in a group-messaging format. For example, Block S150 can push a notification to the human coach including a prompt to support a group of users experiencing similar difficulties in achieving a wellness communication. In this example, Block S150 can send a notification that reciting “these three people need assistance” and wellness program status data for the three users in the group to the human coach via the coaching dashboard. The dashboard can thus enable the human coach to push one communication to multiple users substantially simultaneously, and Block S150 can group users, such as according to elected wellness program, progress through a wellness program, difficulties or successes within a wellness program, ethnographic, demographic, age, gender, etc. in order to share one human coach across multiple users substantially simultaneously.

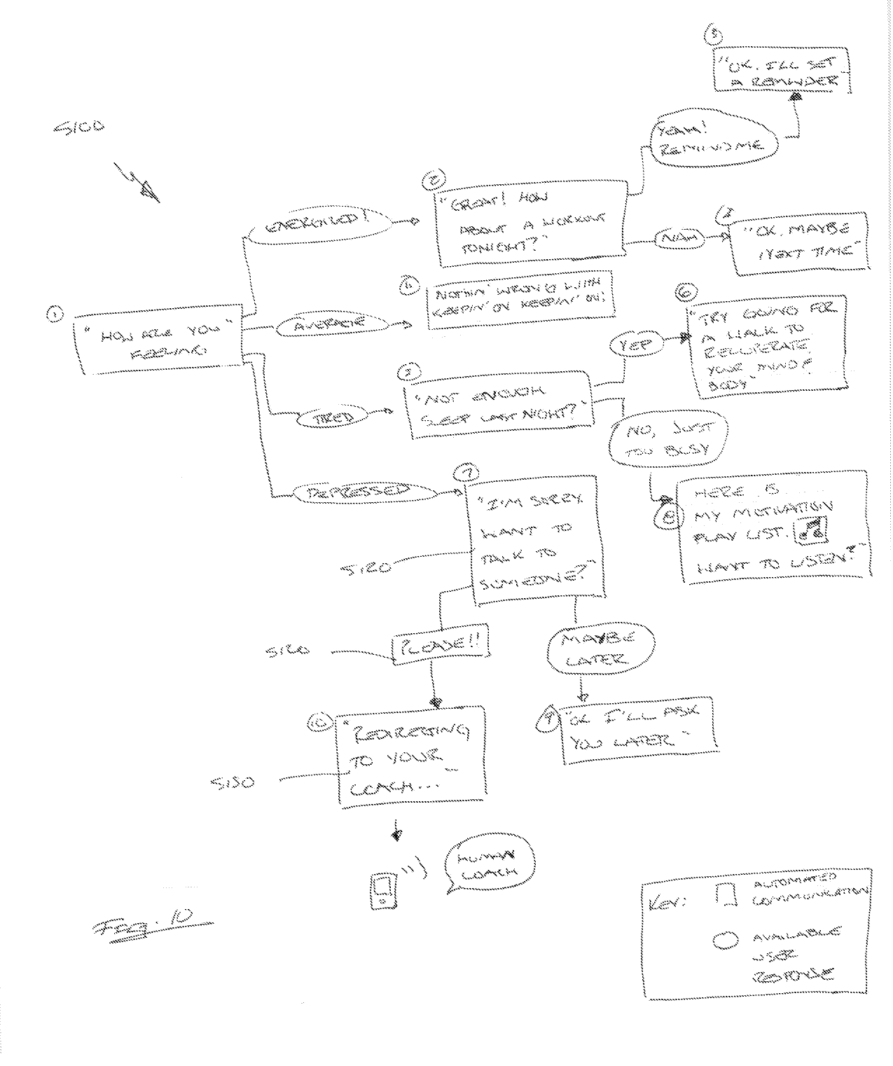

Block S150 can also identify a group of human coaches currently available to communicate with the user and can then select a particular human coach—from the group of human coaches—based on a type of the human involvement trigger. For example, Block S150 can identify a group of available coaches including a first coach specializing in empathizing with users, a second coach specializing in motivating users, a third coach specializing in customization of habit programs or habit blocks for individual users, and a fourth coach specializing in detecting mismatched users and wellness applications and guiding users in selecting alternative wellness applications. In this example, the first method S100 can characterize a user-entered response reciting “I'm feeling depressed” to an auto-generated communication reciting “How are you feeling?” as an acute need for external support, as shown in FIG. 9; Block S150 can thus select the first human coach to provide empathetic messages to the user. In this example, the first method S100 can also characterize a message reciting “I'm about to eat a cupcake—help me!” entered by the user with an acute need to motivate the user; Block S150 can thus select the second human coach to provide motivating messages to the user to avoid the cake.

Block S150 can similarly elect a particular human coach—from a group of available human coaches—to communicate with the user based on the record of user activity data, such as actions or event performed within the last hour, during the current day, or over the past week by the user. For example, Block S150 can select the second coach to provide motivation to the user if the user is with a threshold range of achieving a daily or weekly goal (e.g., a daily step count goal), and Block S150 can select the fourth human coach if the user has failed or failed a substantially portion of directives provided to the user from habit program recently elected by the user.

In another implementation, Block S150 can select a human coach previously in communication with the user (e.g., through the textual conversation feed) to again communicate with the user. Block S150 can thus assign one (or a limited number of) human coach to the user in order to enable the user to build a relationship (e.g., trust) with the human coach over time as communication channels between the user and the human coach are intermittently opened in Blocks S150 an S160.

Similar to Block S130 described above, Block S150 can provide a pre-populated list of communications for the human coach, a current status of the user, a wellness trend of the user (e.g., within the respective wellness application), and/or direction to select a particular communication from the pre-populated list of communications. For example, Block S150 can: populate a set of template communications based on the response; present the set of template communications to the human coach through an instance of a coaching interface associated with the human coach; and then present the response and a limited set of data from the record of activity events. In this example, Block S160 can thus receive, from the human coach, a selection for the second communication from the set of template communications and display a form of the second communication within the textual conversation feed, such as a the template communication customized by the human coach. Block S150 can also apply a rule defined by the wellness application to create the pre-populated list of communications. Additionally or alternatively, Block 150 can prompt the human coach to manually enter a textual message for the user or to select from a personal or external list of potential communications. However, Block S150 can notify the human coach to elect any other suitable communication through any other suitable coaching interface and in response to any other suitable user and/or environmental data.

Block S160 of the first method S100 recites displaying a second communication in the conversation feed in Block S160, the second communication entered by the human coach. Generally, Block S160 implements any one or more techniques of Block S120 and/or Block S140 to push the coach's response to the prompt of Block S150 to the conversation feed of the respective wellness application. Block S160 can push the coach-elected communication to the conversation feed once received from the coach. Alternatively, Block S160 can withhold the second communication for a period of time once received from the coach. For example, Block S160 can withhold the coach-elected communication until a user or environmental event defined by the wellness application occurs. Block S160 can therefore post coach-elected communications to the conversation feed in live with communications from the automated communication generator and/or from the associate of the user.

Like Block S120 and Block S140, Block S160 can also receive a response to the second communication from the user through the conversation feed, and Block S150 and Block S160 can repeat to enable further communication between the user and the coach via the conversation feed. Block S160 can therefore implement any of the first method S100s described above to enable two-way communication (i.e., a conversation) with the user through the conversation feed. However, Block S160 can display the third (i.e., coach-elected) communication in any other way and/or according to any other timing or schema.

In one variation, Blocks S120, S150, and S160 include: correlating the response with a human involvement trigger; within the textual conversation feed, prompting the user to communicate with a human coach; in response to receipt of confirmation to communicate with a human coach from the user, connecting the computing device to a communication device affiliated with a human coach; applying a communication between the user and the human coach to the communication engine to select a second communication for the user; and displaying the second communication within the textual conversation feed, as shown in FIG. 9. In this variation, Block S120 can detect a potential need to connect the user with a human coach (or an associate of the user) based on a response provided by the user to a previous communication and/or based on recent user activity data, and Block S150 can then provide the user an option to engage the human coach immediately, to engage the human coach at some time in the future (e.g., in thirty minutes), or to discard the invitation to connect with the human coach and selectively prompt the human coach to engage the user according to the user's reply.

As described above, Blocks S150 and S160 can connect a human coach to the user through the textual conversation feed within the native wellness platform application. Alternatively, Blocks S150 and S160 can connect a human coach to the user through a (textual) messaging service external the native wellness platform application and/or external a wellness application elected to the user's account by the user. Yet alternatively, Block S150 and S160 can connect a human coach to the user over a telephonic communication channel. For example, Block S150 can interface with a native telephonic application executing on the computer device (external the wellness platform application) to establish a telephone call between the user's computing device (e.g., the user's smartphone) and a communication device (e.g., a smartphone, a computer) affiliated with the human coach.

However, Blocks S150 and S160 (and Blocks S130 and S140) can host communications of any other type between the user and one or more human coaches (and between the user and one or more associates of the user).

### 1.8 Automated Involvement Trigger

In one variation, the first method S100 includes receiving a second response from the user to the second communication through the textual conversation feed; correlating the second response with an automated involvement trigger; based on the automated involvement trigger, applying the second response to the communication engine to generate a fourth communication for the user; and displaying the fourth communication within the textual conversation feed. Generally, in this variation, the first method S100 can implement methods and techniques described above to identify a shift away from the user's need to communicate with a human coach and to thus return to automated communications with the user. For example, Block S150 and S160 can open and maintain communication between the user and a human coach, and Block S120 can implemented natural language processing to monitor messages entered into the textual conversation feed by the user during a textual conversation with the human coach. In this example, Block S110 can shift between nodes within a decision tree corresponding to the related wellness application based on content of messages provided by the user (and by the human coach). In this example, once a node corresponding to an automated involvement trigger is reached, the first method S100 can immediately (or gradually) transition back into providing messages generated automatically for the user, such as messages generated automatically according to a communication engine associated with the wellness application or with the native wellness platform application, as described above.

Alternatively, the first method S100 can rely on the human coach (or the associate of the user) to terminate communications with the user, at which time the first method S100 can return to providing messages generated automatically for the user, as described above.

### 1.9 Situational Logic

In one variation, the method includes: applying the record of activity events performed by the user over a period of time to a logic map to associate the user with a particular status category in a set of status categories defined with the logic map; serving a particular communication engine—from a set of communication engines—corresponding to the particular status category to an instance of the native wellness platform application associated with the user; rendering a first communication defined within the particular communication engine within a textual conversation feed within the instance of the native wellness platform application; presenting a first limited set of responses to the first communication for selection by the user within the instance of the native wellness platform application, the first limited set of responses corresponding to the first communication and defined within the particular communication engine; based on a selection of a particular response from the first limited set of responses by the user, selecting a second communication defined within the particular communication engine; rendering the second communication within the textual conversation feed; presenting a second limited set of responses to the second communication for selection by the user within the instance of the native wellness platform application, the second limited set of responses corresponding to the second communication and defined within the particular communication engine; based on a selection of a particular response from the second limited set of responses by the user, selecting an action prompt defined within the particular communication engine; and rendering the action prompt within the textual conversation feed.

Generally, in this variation, the method can: characterize a current status of the user based on a record of (recent) activity events performed by the user, local ambient and/or weather conditions, and/or previous responses made by the user to communications (e.g., directives); select a particular conversation engine—previously generated and containing various communications for selective delivery to the user—based on the user's current status; and to serve a sequence of communications from the conversation engine to the user through an instance of the native wellness platform application executing on the user's mobile computing device (e.g., smartphone) based on selections by the user from limited sets of pre-populated responses to (and corresponding to) preceding communications thus presented to the user.

In one implementation of the foregoing variation, a database can be manually populated with conversation trees by human coaches, wellness application developers, wellness platform representation, etc., wherein each conversation tree (or conversation engine, conversation decision tree): is associated with a user status or a range of user statuses; includes a sequence or “tree” of possible communications to serve to the user; and includes a limited, pre-populated set of responses to each of at least a subset of communications within the conversation tree, each response in each pre-populated set of responses defining migration to a subsequent communication within the conversation tree for delivery to the user. In this implementation, a remote computer network (e.g., an application server) executing Blocks of the method can retrieve user activity data from a mobile computing device carried by the user and/or a wearable device worn by the user and then assemble these data into a record of user activity events, such as described above, and the remote computer network can then apply data within the user's record to a logic map to characterize the user's current status. For example, the remote computer network can characterize the user with one of: a low sleep, high activity status; a high sleep, low activity status; a high focus, high sleep status; a high focus, low sleep, low activity status; etc. defined in the logic map based on the user's record of activity events. Furthermore, each conversation tree within the database of conversation trees can be associated with a particular user status defined in the logic map, and the remote computer network can thus select a particular conversation tree to serve to the user (e.g., via the user's wellness account, via an instance of the native wellness platform application associated with the user, etc.) based on the characterized status of the user. The particular conversation tree can then be uploaded to the user's mobile computing device and manipulated within the native wellness platform application executing on the user's mobile computing device—as described above—to serve communications from the particular conversation tree over time through the textual conversation feed and based on the user's responses to subsequent communications.

In the foregoing implementation, each conversation tree—contained within or defining a communication engine—can define multiple nodes, wherein each node corresponds to a standard or template communication and a related pre-populated set of responses. Once a particular conversation tree is selected for the user, the method can thus present both a first communication—corresponding to a first node in the particular conversation tree—and corresponding available responses to the first communication to the user through the textual conversation feed. Based on the user's selection from the limited set of responses for the first communication, the method can select a subsequent communication from the conversation tree, as shown in FIG. 10, and serve the subsequent communication and corresponding limited set of responses to the user through the textual conversation feed accordingly. The method can repeat this process until a terminal node (e.g., end node) in the conversation tree is reached.

Terminal nodes (and initial/default nodes and intermediary nodes) in a conversation tree can specify actions to be performed by the user, actions to be performed by the native wellness platform application, and/or actions to be performed by the wellness application, etc., as shown in FIG. 10. For example, a terminal node can trigger the method (e.g., the native wellness platform application or a remote application server executing the method) to associate the user with an alternative status and to select an alternative conversation tree to serve to the user accordingly. In another example, a terminal node can be associated with a human involvement trigger—as described above and shown in FIG. 10—to trigger the method to connect the user with a human coach or with an other associate, such as within the textual conversation feed, in a telephone call, over email, or via an external messaging service. In yet another example, a terminal node can prompt the native wellness platform application to set and later deliver a reminder to the user, such as a reminder to the user to go to sleep early, to stop by a grocery store for more vegetables, or to get a quick workout in later that day. In another example, a terminal node can define a communication prompting the user to share user data or other content on an online social network, and the native wellness platform application can thus direct the user to the online social network in response to selection of the corresponding communication by the user and/or automatically generate a message on behalf of the user to post to the online social network.

Over time, the logic map can be populated with additional user statuses, and the database of conversation trees can be populated with additional conversation trees correspond to the additional user status. A user status defined in the logic map can also be associated with multiple conversation trees, and the method can select a different conversation tree to serve to the user each time the user is characterized by the corresponding user status. For example, the method can prioritize or rank conversation trees corresponding to a status defined within the logic map, and the method can sequentially select conversation trees to serve to the user based on rank where the user is determined to map to the corresponding status.

In the foregoing variation, the methods and techniques described above can be executed locally on the user's mobile computing device. Alternatively, the methods and techniques described above can be remotely, such as by an application server hosting the native wellness platform application, wherein the application server selects particular communications and limited sets of responses corresponding to the particular communications to deliver to the user, uploads selected particular communications and related sets of responses to the user's mobile computing device (or other communication device) for presentation to the user within a textual conversation feed, downloads selections from the sets of responses made by the user, and implements the user's selections to select subsequent communications from the conversation tree, as described above.

### 1.10 Communications Filter

Block S170 of the first method S100 recites estimating a relevance of previous communications within the textual conversation feed to the user at a current time and removing, from the textual conversation feed, a subset of previous communications of estimated relevance less than a threshold relevance. (Block S170 can similarly recite filtering communications in the conversation feed according to an estimated current relevance of the user.) Generally, Block S170 functions to update the conversation feed for the wellness program by removing previous communications that are no longer relevant to the user and/or conflict with a more recent (e.g., current) communication. For example, Block S170 can implement conflict detection and conflict resolution to identify a previous communication within the conversation feed that conflicts with a new communication within the feed and thus remove the previous communication from the conversation feed. For example, if the user has selected a diet program and is currently engaged in a habit program to reduce sodium intake, Block S170 can remove a previous communication to replace beef with fish (with may be high in salt), as a current communication to reduce sodium consumption may conflict at some level with the previous communication. Block S170 can therefore implement retroactive conflict resolution to remove communications posted to the conversation feed over time and that may conflict with a current communication, such as a new communication from the automated communication generator, from an associate of the user, or from a human coach.

Block S170 can additionally or alternatively implement conflict detection and conflict resolution to identify a previous communication within the conversation feed that conflicts with a new communication within a separate conversation feed (i.e., for another wellness application). For example, Block S170 can identify a previous communication in a diet program to reduce carbohydrate consumption as conflicting with a new communication in a fitness program to carb-load prior to an intense workout, and Block S170 can thus remove the previous communication in diet program to eliminate the conflict with the new (i.e., current) communication. However, Block S170 can function in any other way to filter communications in the conversation feed according to an estimated current relevance of the user.

The first method S100 can additionally or alternatively be implemented on a life companion platform that supports life companion applications hosted by one or more live companion partners. For example, the first method S100 can support conversation-reminiscent textual communications between a user and a behavior companion engine, an associate of the user, and a human coach by monitoring the user and prompting and/or generating communications for the user according to current user companion needs. In this example, the first method S100 can monitor the user and/or environmental data and provide communications to assist the user in achieving educational, work-related, family-related, and/or friend-related goals.

### 2. Second Method

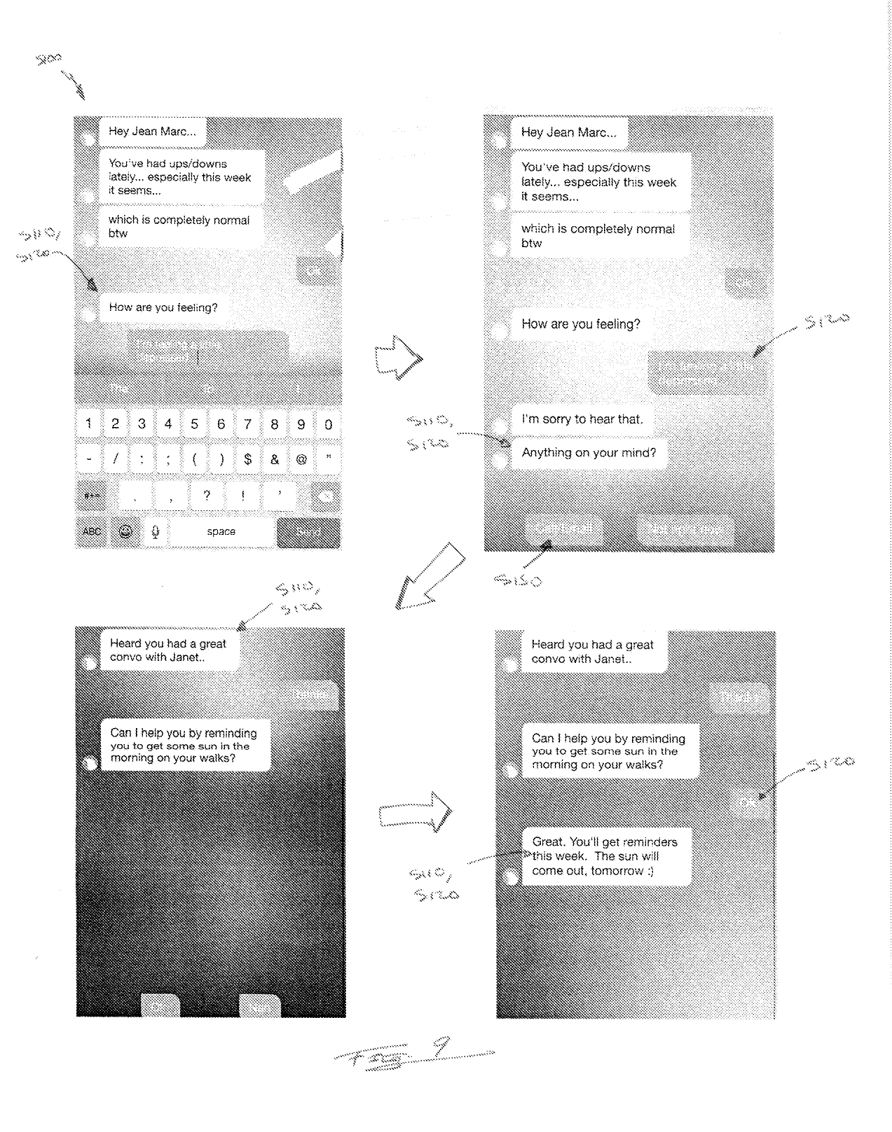

As shown in FIG. 8, a second method S200 for guiding a user through a habit program includes: determining a readiness of the user for the habit program in Block S210; setting a tone for the user in Block S220; selecting a wellness communication including an empathy message based on the readiness of the user and the tone for the user in Block S230; defining an action item within the wellness communication in Block S240; and inserting a measured user metric into the wellness communication in Block S250.

Generally, the second method S200 functions to guide communication selection in Block S110 of the first method S100 described above. Various Blocks of the second method S200 can determine a user's readiness to build or maintain a habit defined in a habit program (described above), an ease with which the user may assume the habit or fulfill actions characterizing the habit, user access to time, materials, locations, etc. necessary to complete actions characterizing the habit, a user tone preference, etc. and then apply these factors to communication selection to output a particular communication that is engaging for the user and includes an action item that the user is capable of fulfilling. The second method S200 can therefore collect various user data and apply these data to communication selection to generate communications that are immediately relevant and useful for the user.

Like Blocks of the first method S100 described above, Blocks of the second method S200 can be implemented locally, such as on a mobile computing device in communication with a wearable device incorporating various inertial sensors, as described in U.S. patent application Ser. No. 14/048,956, filed on 8 Oct. 2013, which is incorporated in its entirety by this reference. Additionally or alternatively, Blocks of the second method S200 can be implemented remotely, such as on computer network or remote database in communication with a wearable device via a mobile computing device.

Block S210 of the second method S200 recites determining a readiness of the user for the habit program. Generally, Block S210 functions to associate the user with a current category of engagement with a habit program. In one example, Block S210 associates the user with a category of engagement in a fitness program characterized by a number of workout periods each week, wherein the selected category of engagement corresponds to how active the user is in completing the number of workout periods each week. In another example, Block S210 associates the user with a category of engagement in a sleep program characterized by a pre-sleep action and a sleep start time, wherein the selected category of engagement corresponds to how active the user is in completing a pre-sleep ritual and putting himself to bed by the sleep start time. Subsequent Blocks of the second method S200 can thus implement the category of engagement to select a type of communication for the user and/or a frequency of delivery of related communications to the user.

In one implementation, Block S210 associates the user with one of a pre-contemplation category, a contemplation category, a preparation category, an action category, and a maintenance category. In this implementation, Block S210 can place the user in the pre-contemplation category for a habit program for which the user is not yet aware (and therefore not presently engaging). For example, if the user is subscribed to a fitness application and is currently engaged in a habit program specifying a target number of steps in a day, Block S210 can place the user in the pre-contemplation category for a subsequent habit program that the user is not yet physically ready to tackle, such as weight lifting. In this example, the second method S200 can respond to the pre-contemplation category assignment for the user by selecting a communication that “seeds” the subsequent habit program in the user's mind, such as by selecting a communication that recites, “Your friend Mike is watching this program while walking on a treadmill at the gym” while the user is sitting on a couch watching television. In this implementation, the pre-contemplating category can also prescribe a substantially low frequency of delivery of associated communications to the user. For example, the pre-contemplating category can prescribe a maximum frequency of one habit program “seeding” communication delivered to the user within any three-day period.

In the foregoing implementation, Block S210 can place the user in the contemplation category for a habit program for which the user is aware but has not yet entered or agreed to enter. For example, some time (e.g., several days) after the second method S200 “seeds” in the user's mind a habit program specifying a weight lifting program, Block S210 can associate the user with the contemplation category, and the second method S200 can respond to this user characterization by pushing to the user a communication reciting, “[ACME GYM] is filled with TV monitors so you can still watch you favorite shows while working out” while the user is sitting on a couch watching television. Block S200 can thus implement the contemplation categorization to select communications that help the user become mentally accustomed to a change corresponding to an upcoming habit program. Furthermore, in this implementation, the contemplating category can also prescribe a low-to-moderate frequency of delivery of associated communications to the user, such as a maximum frequency of one habit program “contemplation” communication delivered to the user within any twenty-four-hour period.

In this implementation, Block S210 can also place the user in the preparation category for a habit program into which the user has recently entered. For example, just after a subsequent habit program is manually confirmed by the user or automatically initiated by the corresponding wellness program, the second method S200 can deliver to the user a communication that recites “You can order all of you workout clothes online from [ACME CLOTHING] while watching this program” while the user is sitting on a couch watching television. Similarly, the second method S200 can deliver to the user a communication that recites “Check out this great walking shoe from [ACME SHOES]—order it today so it's here by Friday, just in time for your new fitness program that starts at the end of this week!” while the user is sitting on a couch watching television. The second method S200 can thus implement the preparation categorization to deliver to the user a communication to guide the user is preparing for the new habit program, such as by prompting the user to collect items (e.g., clothes, food) or manage subscriptions (e.g., to a local gym) preferred or necessary for achievement of the upcoming habit program. In this implementation, the preparation category can prescribe a low frequency of delivery of associated communications to the user, such as a maximum frequency of one habit program “preparation” communication delivered to the user within any two-day period. Alternatively, the preparation category can prescribe a dynamic frequency of delivery of associated communications to the user, such as an increasing frequency of “preparation” communication delivered to the user as a key time, date, or activity prescribed in the habit program nears and/or until the user completes an action specified in a “preparation” communication (e.g., until the user orders a pair of running shoes or workout clothes).

In this implementation, Block S210 can further place the user in the action category for a habit program in which the user is currently actively engaging. For example, while the user is pursuing a fitness program within a fitness application, the second method S200 can implement the action categorization to deliver to the user a communication that recites, “We have a big workout planned for tomorrow, champ! Maybe pack your gym bag right now while you're watching TV so you're all set for tomorrow” while the user is sitting on a couch watching television, the second method S200 thereby providing guidance to the user to achieve a future habit program. Similarly, the second method S200 can implement the action categorization to deliver to the user a communication that recites “You walked 4871 steps on the treadmill, 865 more than during your last workout. Good job, Joe!” once the user completes a workout, the second method S200 thereby responding to a recent user action. In this implementation, the action category can prescribe a relatively high frequency of delivery of associated communications to the user, such as a minimum of three “action” communications delivered to the user within any twenty-four-hour period. The action category can additionally or alternatively prescribe a lower threshold for response to user deviation from a habit such that the second method S200 may deliver a higher frequency of communications that in the preparation and contemplation categories.

In this implementation, Block S210 can place the user in the maintenance category once the user adopts a habit (as described in U.S. patent application Ser. No. 14/048,956) prescribed in a habit program in which the user is currently actively engaged or previous completed. The second method S200 can thus implement the maintenance categorization to deliver occasional communications to the user to support the user in maintaining the current or new-adopted habit. For example, once the user has completed a fitness program within a fitness application and adopted a corresponding habit of running three times each week, the second method S200 can implement the maintenance categorization to deliver a weekly fitness update reciting, “You ran 11.6 miles this week, just shy of your eight-week average of 11.8 miles per week.” In this implementation, the maintenance category can prescribe a relatively low frequency of delivery of associated communications to the user, such as a one “maintenance” communication each week. The maintenance category can additionally or alternatively prescribe a higher threshold for response to user deviation from a habit or prescribe only communications in response to negative deviation from the (positive) habit

Block S210 can therefore assign a category (e.g., one or pre-contemplation, contemplation, preparation, action, and maintenance) to the user (with respect to a particular habit program) based on the user's progress within a wellness application, and subsequent Blocks of the second method S200 can implement thus user categorization to select communication types and frequencies to deliver to the user.

Block S210 can also generate an ‘ease of change’ metric defining an estimated capacity of the user to realize a habit (or goal) prescribed in a habit program. In one implementation, Block S210 generates the ease of change metric by interpolating—from past user data—a demonstrated ability of the user to realize a previous goal. For example, if the user selects a marathon training application six weeks prior to a marathon, Block S210 can analyze past user data to determine if the user has been successful in achieving similarly difficult situations in the past and generate an ease of change “score” accordingly. Subsequent Blocks of the second method S200 can thus implement the ease of change score to select a type of communication and/or a frequency of communications for the user. For example, for a higher user ease of change score, the second method S200 can set a higher frequency of communications and/or a lower threshold deviation from a user habit to deliver a communication to the user. In another example, if the user is on vacation, Block S210 can set a low ease of change score for fulfilling a fitness-related habit program, and second the second method S200 can implement this score to withhold or filter out fitness-related communications from delivery to the user.

Block S210 can also determine user access to a resource necessary for or relevant to achievement of a habit program. For example, Block S210 can access a current time and a current weather or environmental data in the user's location (as described in U.S. patent application Ser. No. 14/048,956) and correlate a current weather condition with user access to a resource. In this example, for a local heat wave or sub-freezing local ambient temperatures, Block S210 can generate a low score for user access to the outdoors, and the second method S200 can apply this low score to filter out or remove from a delivery to the user communications prompting the user to take a walk outside or to catch a breath of fresh air. In another example, if the user does not have a home gym and is not a member at a local gym, Block S210 can set a low score for a gym access, and the second method S200 can implement this score to withhold or filter from delivery to the user communications that prompt the user to go to the gym or lift weights at home. Similarly, if the user does not have a bicycle, Block S210 can set a low score for a bicycle access, and the second method S200 can implement this score to withhold or filter from delivery to the user communications that prompt the user to go on a bike ride.

As described below, subsequent Blocks of the second method S200 can combine readiness, ease of change, and access metrics to select a type frequency, and/or threshold deviation for communications for delivery to user. For example, a Block of the second method S200 can implement these data to identify communications—from a pre-populated list of communication for a habit program—that are not relevant to the user or that the user is likely to ignore (e.g., because the user does not have the resources to fulfill a prompt specified in a communication). In one implementation, the second method S200 selects communications by feeding user and other data into a decision tree with each end-node defining one (or a set of related) communications, and the second method S200 removes or reconfigures nodes within the decision tree to eliminate communications that do not match the user's readiness, ease of change score, and/or access score. For example, Block S240 can also select or filter a set of action items to select a relevant or accessible action item for insertion into a communication, such as by removing a gym workout-related action item from a list of fitness-related action items (e.g., bike ride-, walk-, and run-related action items) for insertion into a communication for the user if Block S210 sets a low user access score for a gym. However, Block S210 can generate an ease of change score and/or an access score in any other way for any other habit program, and the second method S200 can implement the ease of change and access scores in any other suitable way to select a type, frequency, and/or threshold habit deviation for communications for delivery to the user.

Block S220 of the second method S200 recites setting a tone for the user. Generally, Block S220 functions to select a particular tone from a set of tones available for communications in one or more habit programs and/or wellness applications. For example, Block S220 can select a tone type from a set of tone types including a sarcastic tone, a stern or strict tone, or an empathetic tone. Block S220 can select a tone for application to a particular communication, a particular type of communication within a habit program or a wellness application, all communications within a wellness application, or all communications delivered to the user from multiple wellness applications. As described below, a subsequent Block of the second method S200 can then implement the selected tone to modify a communication to exhibit the selected tone. Alternatively, a subsequent Block of the second method S200 can select a particular communication—from a set of comparable communications of different tones—exhibiting or characterized by the selected tone.

In one implementation, Block S220 selects the tone based on a demographic of the user. For example, if the user is a sixteen-year-old female, Block S220 can select a sarcastic tone. In this example, if the user is a forty-year-old marine corps veteran, Block S220 can select a stern tone. Furthermore, if the user is a fifty-five-year-old female, Block S220 can select an empathetic tone.

Alternatively, Block 220 can ‘learn’ the user's preferred tone over time. For example, the second method S200 can deliver communications exhibiting various tone types over time, and Block S220 can collect user responses to the communications and compare these responses to the corresponding tone types to identify which communication tone types are most likely to elicit a response from the user. In this example, for a delivered communications that include action items, if the user responds to an action item prescribed in a communication, Block S220 can determine a positive correlation between the tone and fulfillment of the action item by the user, and if the user does not respond to an action item prescribed in a communication, Block S220 can determine a negative correlation between the tone and fulfillment of the action item by the user. In one example, if a delivered communication recites, “Hey, chubby, take the stairs this time,” and user motion and/or location data collected through a wearable device and/or a mobile computing device (as described in U.S. patent application Ser. No. 14/048,956) indicate that the user took the stairs (despite a user habit for taking an elevator), Block S220 can determine that the user responds well to sarcasm. Similarly, if a delivered communication recites, “Four flights of stairs between you and your office. You will burn 96 calories in the next 58 seconds. There is the stairwell. Go.” and user motion and/or location data indicate that the user took the stairs (despite a user habit for taking an elevator), Block S220 can determine that the user responds well to a strict tone. Block S220 can thus collect these user tone responses over time and then aggregate these data to determine a user preference for a particular tone. However, Block S220 can function in any other way to select or specify a tone for a communication to be delivered to the user.

Block S230 of the second method S200 recites selecting a communication including an empathy message based on the readiness of the user and the tone for the user. Generally, Block S230 functions to select a communication based on new user data, user readiness, user access, etc. to convey validation and/or empathy to the user.

In one implementation, Block S230 applies the user readiness score determined in Block S210 to set a frequency of communication delivery to the user. For example, Block S230 can lower a threshold user deviation from a habit to trigger a communication if the user moves from a preparation stage to an active stage, and Block S230 can similarly increase the threshold user deviation from the habit to trigger a communication if the user moves from the active stage to a maintenance stage.

Block 230 can also apply the determined ease of change score output in Block S210 to set the frequency of communication delivery. For example, if the ease of change score is substantially low for a particular habit program, Block S230 can set relatively high frequency of communications for communications within the habit program. Therefore, in this example, Block S230 can set a higher communication frequency for goals or habit programs that are more difficult for the user to achieve in order to better keep the user on track to achieve the goal or habit program.

In one implementation, as new user data becomes available, Block S230 implements methods or techniques described above and in U.S. patent application Ser. No. 14/048,956 to correlate a detected user deviation from a habit with user effort (or intent) to develop a positive habit (or to eliminate a negative habit). In particular, Block S230 can determine how hard user is working to achieve a goal prescribed based on current habits and determined intentional deviation toward a positive habit and/or away from a negative habit. Block S230 can then select a communication for the user accordingly, such as by passing user data into a decision tree including end nodes defining model communications for eventual delivery to the user.

Therefore, Block S230 can implement a decision tree to select a communication from a pre-populated list of communications specific to a habit program or to a wellness application based on the readiness, ease of change score, and/or access score output in Block S210. For example, Block S230 can filter the decision tree, close or cancel nodes in the decision tree, or otherwise compress the decision tree to remove communications that are not currently relevant to the user. In this example, if the user is only in the contemplation stage within a habit program, Block S230 can filter out or bypass communications specific to an action stage of the habit program.

In one implementation, the decision tree defines end nodes that each include several content-equivalent communications, and each communication within a decision tree node characterized by a different tone. Thus, once Block S230 reaches an end node within the decision tree, Block S230 can further implement the tone output in Block S220 to select a communication of a particular tone from the set of equivalent communications of different tones. Alternatively, Block S230 can select a particular communication based on new user data, user readiness, user access, etc. and then apply a filter to the selected communication based on the tone output in Block S220 to customize the tone of the communication for the user. However, Block S230 can function in any other way to a communication for the user based on user readiness, preferred tone, etc.

Block S240 of the second method S200 recites defining an action item within the communication. Generally, Block S240 functions to insert an action item into the communication selected in Block S230 or to cooperate with Block 230 to select the communication that includes an action item relevant to the user. In particular, Block S240 selects and/or inserts the action item into the communication to provide guidance to the user in building a positive habit and/or moving away from a negative habit.

In one implementation, the decision tree implemented in Block S230 to select the communication includes generic action items at various end nodes, and Block S240 can applies the user access score output in Block S210 to a generic action item selected in Block S230 to customize the generic action item into a final action item that is accessible to the user for completion. For example, Block S230 can select an end node prescribing fifteen minutes of exercise. Subsequently, if Block S210 determines that the user is at home and owns a yoga mat, Block S240 can insert a prompt into the communication suggesting that the user spend fifteen minutes in his practice. However, in this example, if Block S210 determines that the user is at work during a warm sunny day, Block S240 can insert a prompt into the communication suggesting that the user spend fifteen minutes walking outside. Yet alternatively, if Block S210 determines that the user is at work in an empty office during a rainy evening, Block S240 can insert a prompt into the communication suggesting that the user spend a few minutes walking around his office and then complete 100 jumping jacks. Block S240 can therefore select, generate, or modify the communication selected in Block S230 to output a prompt for an action or activity that is available to the user (i.e., suitable for relatively immediate completion by the user).

Block S240 can therefore customize a selected communication to limit or prevent delivery of action items that the user cannot actually complete or that the user would find particularly difficult or uncomfortable to complete, thereby maintaining efficacy of communications delivered to the user and thus user engagement in a corresponding wellness program. However, Block S240 can function in any other way to define the action item within the wellness communication.

Block S250 of the second method S200 recites inserting a measured user metric into the wellness communication. Generally, Block S250 functions to customize the communication for the user by inserting real user data into the communication. The communication can therefore serve to inform the user of an action and/or progress within a habit program through real measured user data, such as data collected through a wearable device and/or mobile computing device, as described above. On one implementation, Block S250 can accesses a determined user action, activity, and/or corresponding duration, start time, end time, location, etc. and then inserts any of these data into a ‘blank’ within the communication, such as a current number of steps completed on the user on the present, and average number of steps per day within the last week, a distance completed on a current or recent run, or a number of jumping jacks, pushups, and bench-press reps competed during a current workout.

Block S250 can also insert into the communication a comparison of new or current user data to past user data. In particular, Block S250 can insert into the communication an indicator of user deviation from a user habit or a similar previous user action or activity. For example, Block S250 can insert into the communication a message that recites, “Hey Jim—you averaged about 4,000 each day for the last two months, but today you walked nearly 8,750 steps. Way to go!” Block S250 can similarly insert in to the communication a message that recites, “Jim, you made is to the gym one more day this week than usual. Does it feel like you're getting stronger?” or that recites, “Jim, you ran 8.3 miles last week, but you completed 11.0 miles this week. What prompted the extra mileage?” Block S250 can therefore also customize the communication to prompt the user to comment on a deviation from a habit or common user action or activity.

Once the communication is thus completed through various Blocks of the second method S200, the first method S100 can deliver the communication to the user, such as in the form of a textual notification or in the form of a audible recitation presented on the user's smartphone, tablet, or other computing device, as described above. However, the second method S200 can function in any other way to generate and/or customize a communication for a user.

The systems and methods of the preferred embodiment can be embodied and/or implemented at least in part as a machine configured to receive a computer-readable medium storing computer-readable instructions. The instructions are preferably executed by computer-executable components preferably integrated with the application, applet, host, server, network, website, communication service, communication interface, hardware/firmware/software elements of a user computer or mobile device, wristband, smartphone, or any suitable combination thereof. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

I claim:

1. A method for providing wellness-related communications to a user comprising:
applying a record of activity events performed by the user over a period of time to a communication engine to generate a first communication for the user, the communication engine supported within a native wellness platform application executing on a computing device affiliated with the user;
displaying the first communication within a textual conversation feed within the native wellness platform application;
receiving a response to the first communication from the user through the textual conversation feed;
correlating the response with a human involvement trigger;
based on the human involvement trigger, prompting a human coach to communicate with the user; and
displaying a second communication within the textual conversation feed, the second communication entered by the human coach.

2. The method of claim 1, further comprising:
receiving a second response from the user to the second communication through the textual conversation feed;
correlating the second response with an automated involvement trigger;
based on the automated involvement trigger, applying the second response to the communication engine to generate a third communication for the user; and
displaying the third communication within the textual conversation feed.

3. The method of claim 1, wherein applying the record to the communication engine comprises:
passing data from the record into a decision tree to select a first node from a set of nodes defined within the decision tree, the communication engine comprising the decision tree;
selecting a first template communication, from a set of template communications, corresponding to the first node; and
customizing the first template communication with data from the record to generate the first communication.

4. The method of claim 3, wherein receiving the response from the user comprises receiving a textual response entered by the user into a text field within the textual conversation feed; wherein correlating the response with the human involvement trigger comprises categorizing the textual response as a particular response type and applying the particular response type to the decision tree to shift from the first node to a second node in the set of nodes within the decision tree; and wherein correlating the response with the human involvement trigger comprises identifying the human involvement trigger corresponding to the second node.

5. The method of claim 1, wherein prompting the human coach to communicate with the user comprises identifying a group of human coaches currently available to communicate with the user and selecting the human coach from the group of human coaches based on a type of the human involvement trigger.

6. The method of claim 1, wherein prompting the human coach to communicate with the user comprises selecting the human coach previously in communication with the user through the textual conversation feed.

7. The method of claim 6, further comprising:
populating a set of template communications based on the response;
presenting the set of template communications to the human coach through an instance of a coaching interface associated with the human coach; and
presenting the response and a limited set of data from the record of activity events;
wherein displaying the second communication within the textual conversation feed comprises receiving, from the human coach, a selection for the second communication from the set of template communications and displaying a form of the second communication within the textual conversation feed.

8. The method of claim 7, wherein displaying the second communication within the textual conversation feed further comprises receiving, from the human coach, the second communication comprising a template communication, selected from the set of template communications, customized by the human coach based on the response and the limited set of data from the record of activity events.

9. The method of claim 1, estimating a relevance of previous communications within the textual conversation feed to the user at a current time and removing, from the textual conversation feed, a subset of previous communications of estimated relevance less than a threshold relevance.

10. The method of claim 1, wherein displaying the first communication within the textual conversation feed comprises displaying the first communication and a limited set of available responses to the first communication within the textual conversation feed; and wherein receiving the response from the user comprises receiving a selection for the response from limited set of available responses.

11. The method of claim 1, wherein applying the record to the communication engine comprises collecting a first set of action data of the user from a wearable device worn by the user during the period of time, collecting a second set of action data of the user from a mobile computing device associated with the user during the period of time, and fusing the first set of action data and the second set of action data into discrete activity events performed by the user during the period of time.

12. The method of claim 1, further comprising prompting an associate of the user to select a third communication from a set of messages based on the human involvement trigger; and displaying the third communication with the second communication within the textual conversation feed.

13. A method for providing wellness-related communications to a user comprising:
applying a record of activity events performed by the user over a period of time to a communication engine to generate a first communication for the user, the communication engine supported within a native wellness platform application executing on a computing device affiliated with the user;
displaying the first communication within a textual conversation feed within the native wellness platform application;
receiving a response to the first communication from the user through the textual conversation feed;
correlating the response with a human involvement trigger;
within the textual conversation feed, prompting the user to communicate with a human coach;
in response to receipt of confirmation to communicate with a human coach from the user, connecting the computing device to a communication device affiliated with a human coach;
applying a communication between the user and the human coach to the communication engine to select a second communication for the user; and
displaying the second communication within the textual conversation feed.

14. The method of claim 13:
wherein applying the record to the communication engine comprises passing data from the record into a decision tree to a first node within the decision tree and selecting the first communication, from a set of stock communications, corresponding to the first node;
wherein receiving the response from the user comprises receiving a textual response entered by the user into a text field within the textual conversation feed;
wherein correlating the response with the human involvement trigger comprises correlating the textual response with a response type and applying the response to the decision tree to move from the first node to a second node within the decision tree; and
wherein correlating the response with the human involvement trigger comprises identifying the human involvement trigger corresponding to the second node.

15. The method of claim 13, wherein connecting the computing device to the communication device affiliated with the human coach comprises interfacing with a native telephonic application executing on the computer device to establish a telephone call between the computing device and the communication device.

16. The method of claim 13, further comprising selecting a subset of data from the record of activity events and transmitting the subset of data and the response to the communication device in response to receipt, from the user, of confirmation to communicate with the human coach.

17. The method of claim 13, wherein applying the record of activity events to the communication engine comprises applying the record of activity events to the communication engine corresponding to a wellness application affiliated with a third-party service, selected by the user, and hosted within the native wellness platform application executing on the computing device; and wherein connecting the computing device to the communication device affiliated with the human coach comprises selecting the human coach affiliated with the third-party service.

18. The method of claim 13, wherein applying the record to the communication engine to generate the first communication comprises:
retrieving a user preference for tone of communications delivered to the user;
selecting a template communication for delivery to the user based on the record of activity events; and
customizing the template communication into the first communication based on the user preference for tone.

19. The method of claim 13, wherein applying the record to the communication engine to generate the first communication comprises determining a level of engagement of the user in a wellness program hosted within the native wellness platform application based on the record of activity events, defining a trigger for delivery of the first communication to the user, and setting a maximum frequency of communications to the user within a period of time based on the level of engagement; and wherein displaying the first communication within the textual conversation feed comprises displaying the first communication within the textual conversation feed in response to detection of the trigger in the record of activity events based on a number of communications rendered within the textual communication feed within a current period of time falling below the maximum frequency of communications.

20. The method of claim 13, wherein applying the record to the communication engine comprises collecting a first set of action data of the user from a wearable device worn by the user during the period of time, collecting a second set of action data of the user from a mobile computing device associated with the user during the period of time, and fusing the first set of action data and the second set of action data into discrete activity events performed by the user during the period of time.
